(19) United States
(12) Patent Application Publication
(10) Pub. No.: US 2014/0297558 A1
(43) Pub. Date: Oct. 2, 2014

(54) STORE RANKING DEVICE, ORGANIZATION RANKING DEVICE, AND STORE RANKING METHOD

(71) Applicant: PANASONIC CORPORATION, Osaka (JP)

(72) Inventor: Emi KARIBE, Osaka (JP)

(73) Assignee: PANASONIC CORPORATION, Osaka (JP)

(21) Appl. No.: 14/197,041

(22) Filed: Mar. 4, 2014

(30) Foreign Application Priority Data
Mar. 27, 2013 (JP) 2013-065900
Dec. 24, 2013 (JP) 2013-266154

(51) Int. Cl. G06Q 30/02

(52) U.S. Cl. CPC G06Q 30/0282
USPC 705/347

(57) ABSTRACT

A store ranking device calculates, for each of stores, a store score of the store based on purchase information and a producer score, ranks the stores based on the calculated store scores, and outputs ranking information indicating the ranks of the stores, the purchase information including information indicating at least one producer who provides the store with a product and information indicating a quantity of the product provided by the at least one producer, and the producer score being determined for each of the at least one producer and indicating sensitivity of the at least one producer to sustainability of a society.

### Cross Reference to Related Applications

The present application is based on and claims priority of Japanese Patent Application No. 2013-65900 filed on Mar. 27, 2013 and Japanese Patent Application No. 2013-266154 filed on Dec. 24, 2013. The entire disclosure of the above-identified application, including the specification, drawings and claims is incorporated herein by reference in its entirety.

### FIELD

The present disclosure relates to a store ranking device that evaluates the contribution, of a store providing products and services, to enhancement of the sustainability of a society.

### BACKGROUND

In recent years, mainly in developed countries, a movement aimed at establishing a society where current needs are satisfied in consideration of future generations, that is, a sustainable society is gaining momentum for rapidly worsening global environmental problems.

Against this backdrop, there is a growing need for knowing, before products and services are consumed, whether or not the products and the services are provided through production activities sensitive to the sustainability of the society.

### SUMMARY

However, there has not been developed a method for quantitatively evaluating whether or not stores/companies select and concentrate products and services based on their sensitivity to the sustainability of the society. Thus, it has been impossible to present information about the stores/companies to a consumer based on the sensitivity to the sustainability of the society.

One non-limiting and exemplary embodiment provides a store ranking device that makes it possible to present to a consumer information indicating an evaluation whether or not a store/company is sensitive to the sustainability of a society.

In one general aspect, the techniques disclosed here feature a store ranking device that ranks a plurality of stores to support a consumption behavior of a user which is sensitive to sustainability of a society, the store ranking device including a processor that (i) calculates, for each of the stores, a store score of the store based on purchase information and a producer score, (ii) ranks the stores based on the calculated store scores, and (iii) outputs ranking information indicating the ranks of the stores, the purchase information including (a) information indicating at least one producer who provides the store with a product and (b) information indicating a quantity of the product provided by the at least one producer, and the producer score being determined for each of the at least one producer and indicating sensitivity of the at least one producer to the sustainability of the society.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram illustrating an exemplary display screen of an information communication device of a user of a service provided by a store ranking device according to Embodiment 1.

FIG. 2 is a block diagram illustrating a configuration of a store ranking system according to Embodiment 1.

FIG. 3 is a flow chart for operations performed by the store ranking system according to Embodiment 1.

FIG. 4 is a diagram illustrating an exemplary sustainability evaluation table according to Embodiment 1.

FIG. 5 is a diagram illustrating an exemplary method for calculating a producer score.

FIG. 6 is a diagram illustrating another exemplary method for calculating a store score.

### DESCRIPTION OF EMBODIMENTS

### (Underlying Knowledge Forming Basis of the Present Disclosure)

In recent years, mainly in developed countries, a movement aimed at establishing a society where current needs are satisfied in consideration of future generations, that is, a sustainable society is gaining momentum for rapidly worsening global environmental problems.

In particular, consumers are required to perform consumption behaviors sensitive to the environment and social ethics. The consumers are required to change their awareness of considering whether or not their consumption supports the establishment of the sustainable society in every aspect of the consumption such as selection of diet, housing environment, and transportation.

For instance, in the United States, a movement to lead the establishment of the sustainable society has been initiated by consumers, centering around a social movement by citizens. The United States has seen the emergence of “ethical consumers” who support buying environmentally-friendly products while boycotting environmentally-unfriendly products and making an accusation. The ethical consumers make positive efforts to select products and services sensitive to the environment and the social ethics, and to support companies providing such products or services.

Against this backdrop, there is a growing need for knowing, before products and services are consumed, whether or not the products and the services are provided through production activities sensitive to the sustainability of the society.

Unfortunately, it is difficult and complicated for users to judge the sensitivity of each of a huge number of products and services to the sustainability of the society. Moreover, it is largely up to distributors, curators, and so on (hereinafter also referred to as stores/companies), who select and concentrate products and services and then provide them, to judge the sensitivity of the products and the services to the sustainability of the society. Thus, there is a growing need for information that the users use to select the stores/companies which select and concentrate the products and the services, based on the sensitivity of the products and the services to the sustainability of the society.

On the other hand, a technique for identifying a topic in which a user is interested and sorting ranks of search results is known as, for example, a method for extracting, from a huge number of information items on the Internet, information demanded by a user (see Patent Literature (PTL) 1 (Japanese Unexamined Patent Application Publication (Translation of PCT Application) No. 2007-531160), for instance). In addition, there is a technique for sorting search results according to the current status (state) of a user (see PTL 2 (Japanese Unexamined Patent Application Publication No. 2010-128777), for example).

According to the configurations of PTLs 1 and 2, it is possible to obtain, from a user, a topic in which the user is interested or a situation of the user, and to preferentially present to the user information about suitable stores/companies by sorting search results of information using the topic or the situation as an index.

However, there has not been developed a method for quantitatively evaluating whether or not a store/company selects and concentrates products and services based on their sensitivity to the sustainability of the society. Thus, it has been impossible to present information about the stores/companies to consumers based on the sensitivity to the sustainability of the society.

In view of such a situation, the inventors have conceived the present disclosure.

Hereinafter, embodiments are described in greater detail with reference to the accompanying Drawings. Please note that an excessively detailed description may be omitted. For instance, a detailed description of an already well-known matter or a duplicated description for the substantially same configuration may be omitted. This allows for preventing the following description from becoming unnecessarily redundant and for facilitating understanding of a person skilled in the art.

It is to be noted that the inventors provide the accompanying Drawings and the following description so that the person skilled in the art would sufficiently understand the present disclosure, and it is not intended that these limit the subject matter recited in the CLAIMS.

### Embodiment 1

### (1-1. Overview)

First, the overview of a service provided by a store ranking device according to Embodiment 1 is described.

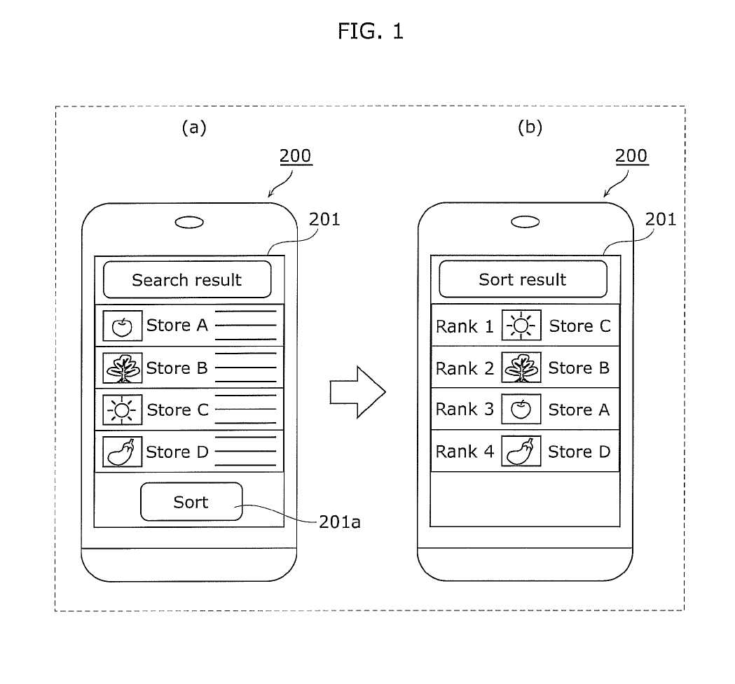

FIG. 1 is a diagram illustrating an exemplary display screen of an information communication device of a user of a service provided by the store ranking device according to Embodiment 1.

Before buying a product (target product), a user of a search service provided by a store ranking device first searches for information about stores from which the user can buy the target product, using an information communication device 200. At this time, as illustrated in (a) of FIG. 1, a display unit 201 of the information communication device 200 displays, as search results, the information about the stores from which the user can buy the target product. In an example illustrated in (a) of FIG. 1, the display unit 201 of the information communication device 200 displays information about four stores, Store A, Store B, Store C, and Store D.

Here, if the user touches a sorting button (region 201a) in the display unit 201, the store ranking device transmits to the information communication device 200 ranking information indicating ranks of the stores when the stores are ranked based on their sensitivity to the sustainability of the society. With this, as illustrated in (b) of FIG. 1, the information about the stores is sorted based on the sensitivity to the sustainability of the society. In an example illustrated in (b) of FIG. 1, the stores are sorted in descending order of the sensitivity to the sustainability of the society, and the sorted stores are displayed. In other words, in the example illustrated in (b) of FIG. 1, Store C is most sensitive to the sustainability of the society, followed by Store B and then by Store A. Among the four stores, Store D is least sensitive to the sustainability of the society.

The following describes in detail a store ranking system (store ranking device) according to Embodiment 1.

### (1-2. Configuration)

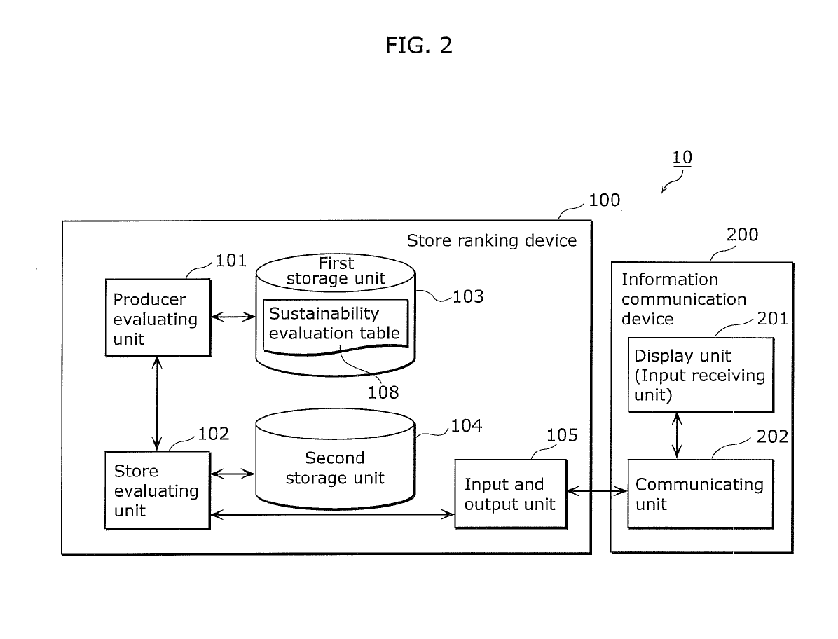

FIG. 2 is a block diagram illustrating a configuration of the store ranking system according to Embodiment 1.

As illustrated in FIG. 2, a store ranking system 10 includes a store ranking device 100 and the information communication device 200.

First, the store ranking device 100 is described.

The store ranking device 100 includes a producer evaluating unit 101, a store evaluating unit 102, a first storage unit 103, a second storage unit 104, and an input and output unit 105.

The store ranking device 100 ranks stores/companies using their sensitivity to the sustainability of the society as indexes, and presents to the user information about the ranked stores. The store ranking device 100 is specifically a server, but may be another device.

The producer evaluating unit 101 calculates a producer score of a producer based on the producer's sensitivity to the sustainability of the society. The producer score is an evaluation value indicating the sensitivity of the producer to the sustainability of the society. The details of a method for calculating a producer score are described later.

The store evaluating unit 102 calculates a store score of a store based on purchase information and a producer score. The details of a method for calculating a store score are described later.

In addition, the store evaluating unit 102 ranks stores based on calculated store scores. To put it another way, the store evaluating unit 102 generates ranking information indicating the ranks of the stores.

The first storage unit 103 stores a sustainability evaluation table 108 (evaluation table) referred to by the producer evaluating unit 101 to calculate a producer score.

The second storage unit 104 stores producer scores calculated by the producer evaluating unit 101, purchase information, and information about stores/companies.

The purchase information includes information indicating producers who provide products to stores, and information indicating quantities of the products (the numbers of the products) provided by the producers. The purchase information and the information about the stores/companies are collected by a research company, for instance, and previously stored in the second storage unit 104. It is to be noted that the information indicating the numbers of products included in the purchase information varies from day to day, but average values are used as an example of such information in this embodiment.

The first storage unit 103 and the second storage unit 104 each are specifically a semiconductor memory such as a flash memory, a ferroelectric memory, or a recording medium such as a hard disk drive (HDD). It is to be noted that the first storage unit 103 and the second storage unit 104 may each be a database provided outside of the store ranking device 100 and connected to the store ranking device 100 through a communication network.

The input and output unit 105 (output unit) outputs the ranking information indicating the ranks of the stores. Specifically, the input and output unit 105 transmits the ranking information to a communication unit 202 of the information communication device 200.

Moreover, if a search request of the user for stores is input to the input and output unit 105 from the communication unit 202 through the network, the input and output unit 105 outputs, as search results, information about stores satisfying search conditions included in the search request. It is to be noted that the information about the stores satisfying the search conditions is provided from a database provided inside or outside the store ranking device 100.

Furthermore, if a sort request is input to the input and output unit 105 from the communication unit 202 of the information communication device 200, the store evaluating unit 102 calculates store scores and ranks stores based on the calculated scores. It is to be noted that if a search request is input to the input and output unit 105, the store evaluating unit 102 may calculate store scores, and the input and output unit 105 may transmit ranking information.

The input and output unit 105 is an HTTP server accessible through the communication network from a browser of the information communication device 200, for instance.

Next, the information communication device 200 is described.

The information communication device 200 includes the display unit 201 and the communication unit 202.

Although the information communication device 200 is a smart phone as illustrated in FIG. 1 in Embodiment 1, the information communication device 200 may be any device as long as the device has a communication function like a personal computer and a table terminal, and is capable of receiving services provided by the store ranking device 100.

The communication unit 202 communicates with the store ranking device 100. Specifically, as described with reference to FIG. 1, if the user touches the region 201a with the intention to sort the information about the stores, the communication unit 202 transmits the sort request to the input and output unit 105 of the store ranking device 100. In addition, the communication unit 202 receives the ranking information output from the input and output unit 105 of the store ranking device 100.

When the communication unit 202 receives the search results, the display unit 201 displays the information about the stores as illustrated in (a) of FIG. 1. In addition, when the communication unit 202 receives the ranking information, the display unit 202 sorts the information about the stores according to the ranks indicated by the ranking information and displays the sorted information as illustrated in (b) of FIG. 1.

The display unit 201 is a liquid crystal panel or an organic electro luminescent (EL) panel, for example. It is to be noted that the display unit 201 is overlaid with a touch panel and also serves as an input receiving unit that receives an input of the user in Embodiment 1.

It is to be noted that the producer evaluating unit 101, the store evaluating unit 102, and the input and output unit 105 are implemented by software. Specifically, the functions of the producer evaluating unit 101, the store evaluating unit 102, and the input and output unit 105 are achieved by a CPU, which is provided in the store ranking device 100, executing the software stored in a recording medium such as a ROM, an EEPROM, and an HDD included in the store ranking device 100.

Nonetheless, the producer evaluating unit 101, the store evaluating unit 102, and the input and output unit 105 may be configured with dedicated hardware.

### (1-3. Operation)

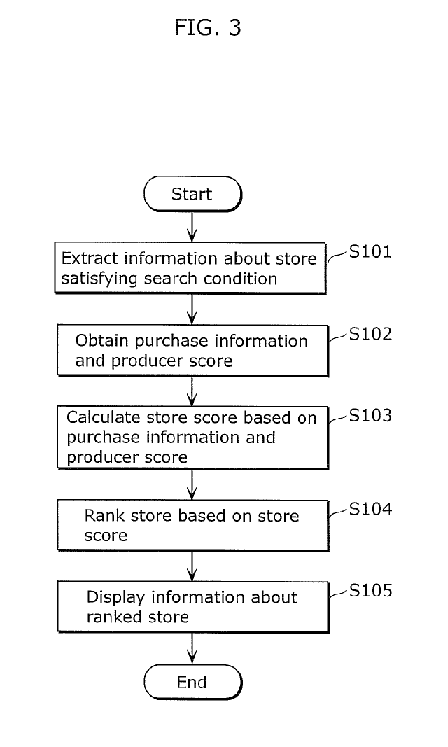

Next, the operations of the store ranking system 10 are described with reference to FIG. 3. FIG. 3 is a flow chart for the operations performed by the store ranking system 10.

It is to be noted that Embodiment 1 describes, as an example, a case where if a user looks for a grocery store in a neighborhood of a user's residence, the store ranking device 100 presents information about grocery stores ranked based on the sensitivity of the grocery stores to the sustainability of the society. It is to be noted that the flow chart of FIG. 3 illustrates the operations when the display unit 201 displays the information about the ranked stores as illustrated in (b) of FIG. 1 if the store ranking device 100 receives a search request from the user.

First, the store ranking device 100 receives a search request from the user and extracts information about stores in a neighborhood of a user's residence (S101). Specifically, the input and output unit 105 receives the search request from the communication unit 202, and the store evaluating unit 102 extracts the information about the stores satisfying search conditions included in the search request, from a database provided inside or outside the store ranking device 100.

Next, the store evaluating unit 102 obtains, for each of the stores extracted in step S101, purchase information of the store and producer scores of producers who provide products to the store (S102). Specifically, the store evaluating unit 102 reads the purchase information and the producer scores from the second storage unit 104.

Next, the store evaluating unit 102 calculates store scores from the purchase information and the producer scores obtained in step S102 (S103). Then, the store evaluating unit 102 ranks the stores based on the store scores calculated in step S102 (S104).

The input and output unit 105 outputs to the communication unit 202 ranking information indicating the ranks of the stores based on the store scores calculated by the store evaluating unit 102. As a result, the display unit 201 of the information communication device 200 displays the information about the stores sorted according to the ranking information received by the communication unit 202 (S105).

### (1-4. Method for Calculating a Producer Score)

Next, the method for calculating a producer score performed by the producer evaluating unit 101 is described. The producer evaluating unit 101 calculates producer scores using the sustainability evaluation table 108.

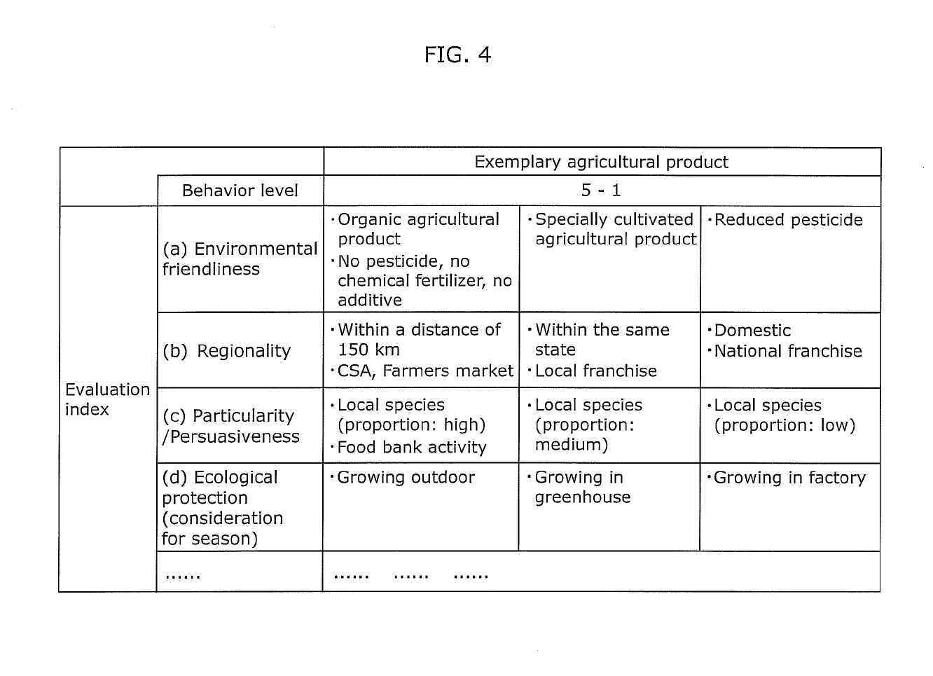

FIG. 4 is a diagram illustrating an exemplary sustainability evaluation table 108 according to Embodiment 1. It is to be noted that the sustainability evaluation table 108 is created based on an assumption that producers provide, as products, agricultural products to stores in Embodiment 1.

The sustainability evaluation table 108 vertically lists evaluation indexes. Specifically, the sustainability evaluation table 108 lists, as the evaluation indexes, characteristic behaviors in production processes of products and services regarding the sensitivity to the sustainability of the society.

Moreover, the sustainability evaluation table 108 horizontally lists behavior levels. It is to be noted that the following description assumes that the behavior level in the left column is Behavior Level 5 (5 points), the behavior level in the central column is Behavior Level 3 (3 points), and the behavior level in the right column is Behavior Level 1 (1 point) in FIG. 4. The higher a behavior level is (the higher a point is), the more a behavior is sensitive to the sustainability of the society, and the more highly the behavior is evaluated.

In the sustainability evaluation table 108, the evaluation indexes include (a) Environmental friendliness, (b) Regionality, (c) Particularity/Persuasiveness, and (d) Ecological protection.

The evaluation index (a) represents environmental friendliness to soil such as regulations on the use of pesticide and chemical fertilizer. In other words, a used amount of pesticide and chemical fertilizer or the like is used as an evaluation criterion for the evaluation index (a). If the attention is given to the environmental friendliness, producers who produce organic agricultural products and producers who produce agricultural products without pesticide and chemical fertilizer correspond to Behavior Level 5. To put it another way, such producers are sufficiently sensitive to the sustainability of the society and evaluated highly.

In contrast, if the number of times pesticide to be reduced is used in production processes of agricultural products is less than 50% of a reference level (conventional level), producers who use minimum necessary pesticide and producers who produce specially cultivated agricultural products correspond to Behavior Level 3.

In addition, producers who use pesticide at a level beyond the reference level though reducing the used amount of the pesticide correspond to Behavior Level 1. Stated differently, such producers are insufficiently sensitive to the sustainability of the society and evaluated lowly.

The evaluation index (b) represents regionality in which as many agricultural products as possible are sold and consumed within a radius of 150 km from places where the agricultural products are produced. In other words, a distance between a production place of a product and a sales place of the product is used as an evaluation criterion for the evaluation index (b). If the attention is given to the regionality, producers who sell agricultural products produced within the radius of 150 km from the places where the agricultural products are produced correspond to Behavior Level 5. Such production of the agricultural products is also referred to as community supported agricultural (CSA).

Moreover, if the attention is given to modes of marketing as the regionality, a store format of a store which sells products produced or processed by producers or a size of a branch store of the store is used as the evaluation criterion. In this case, producers who hold a farmers market correspond to Behavior Level 5. Here, the farmers market is a market where producers themselves directly sell consumers agricultural products.

In contrast, producers who sell agricultural products at places beyond a radius of 150 km from places where the agricultural products are produced, e.g. places at a distance of a state level (the term “state” refers to a U.S. state), correspond to Behavior Level 3. If the attention is given to the modes of marketing as the regionality, producers who make a sale at local franchise stores correspond to Behavior Level 3.

Moreover, producers who sell agricultural products at places beyond a radius of 150 km from places where the agricultural products are produced, e.g. places at a distance beyond the state level, correspond to Behavior Level 1. If the attention is given to the modes of marketing as the regionality, producers who make a sale at national franchise stores correspond to Behavior Level 1.

The evaluation index (c) represents particularity such as consciously growing agricultural products of species affecting soil and surrounding environments less and originated in producing areas. A ratio of an agricultural product of a species originated in a producing area is used as an evaluation criterion for the evaluation index (c).

Producers having high proportions of agricultural products of species originated in producing areas correspond to Behavior Level 5, and producers having low proportions of agricultural products of species originated in producing areas correspond to Behavior Level 1. In addition, producers whose proportions of agricultural products of species originated in producing areas are approximately intermediate between Behavior Level 5 and Behavior Level 1 correspond to Behavior Level 3.

Moreover, the number of times a welfare activity is conducted using agricultural products may be used as the evaluation criterion from a standpoint of the “particularity.” If the attention is given to the number of times the welfare activity is conducted using the agricultural products, producers who conduct food bank activities correspond to Behavior Level 5. A food bank activity is a welfare activity in which agricultural products that have no questionable quality but are difficult to sell due to their external defects or the like are provided at no charge.

The evaluation index (d) represents ecological protection (consideration for season) in which an agricultural product is not forcibly produced in disregard of a production period, and an agricultural product in season that matches an appropriate climate is produced, from a standpoint of ecosystem protection. If the attention is given to the ecological protection, producers who produce agricultural products outdoors correspond to Behavior Level 5. Producers who produce agricultural products in green houses correspond to Behavior Level 3, because the producers are considered to delay a production period. Producers who produce agricultural products in factories correspond to Behavior Level 1, because the producers are considered to delay a production period more than the producers using the green houses.

By using the sustainability evaluation table 108 as described above, the producer evaluating unit 101 makes it possible to evaluate the sensitivity of the producers to the sustainability of the society, and to calculate the produce scores for ranking the producers.

It is to be noted that the evaluation indexes in the sustainability evaluation table 108 are merely an example, and the present disclosure is not limited to such evaluation indexes. For instance, consideration for CO₂ emission, energy conservation measures, water conservation, and so on may be used as evaluation indexes and evaluation criteria.

Next, a specific exemplary method for calculating a producer score is described.

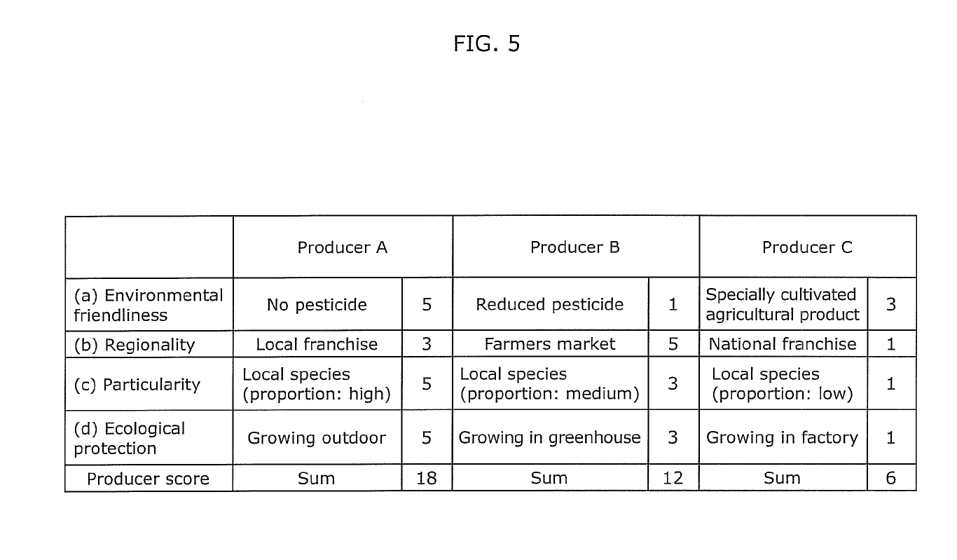

FIG. 5 is a diagram illustrating an exemplary method for calculating a producer score. In an example shown in FIG. 5, assuming that a behavior level is a point, a producer score is expressed as the point for each of Producer A, Producer B, and Producer C.

In the example shown in FIG. 5, the producer evaluating unit 101 reads the sustainability evaluation table 108 from the first storage unit 103, and refers to evaluation indexes included in the read sustainability evaluation table 108. Then, the producer evaluating unit 101 determines an evaluation value for each of the referred evaluation indexes, and calculates a sum of the evaluation values as a producer score.

As shown in FIG. 5, because Producer A produces agricultural products without pesticide, Producer A deserves Behavior Level 5 for the environmental friendliness. Likewise, because Producer A sells the agricultural products at local franchise stores, Producer A deserves Behavior Level 3 for the regionality. Similarly, Producer A deserves Behavior Level 5 for “Particularity” and Behavior Level 5 for the ecological protection. In the example shown in FIG. 5, a producer score is a sum of points for the evaluation indexes. Thus, the producer score of Producer A is calculated as 5+3+5+5=18 points.

Because Producer B produces agricultural products with reduced pesticide, Producer B deserves Behavior Level 1 for the environmental friendliness. Likewise, because Producer B sells the agricultural products at farmers markets, Producer B deserves Behavior Level 5 for the regionality. Similarly, Producer B deserves Behavior Level 3 for “Particularity” and Behavior Level 3 for the ecological protection. Thus, the producer score of Producer B is calculated as 1+5+3+3=12 points.

Because Producer C produces specifically cultivated agricultural products, Producer C deserves Behavior Level 3 for the environmental friendliness. Likewise, because Producer C sells the agricultural products at national franchise stores, Producer C deserves Behavior Level 1 for the regionality. Similarly, Producer C deserves Behavior Level 1 for “Particularity” and Behavior Level 1 for the ecological protection. Thus, the producer score of Producer C is calculated as 3+1+1+1=6 points.

Consequently, in the example shown in FIG. 5, Producer A, Producer B, and Producer C are ranked in descending order of producer score.

It is to be noted that the method for calculating a producer score illustrated in FIG. 5 is a merely example, and the present disclosure is not limited to such a method for calculating.

It is to be noted that information about each of producers (e.g., whether or not each producer produces agricultural products without pesticide) can be obtained from a food inspection and authorization agency, a research company, or the like.

### (1-5. Method for Calculating a Store Score)

Next, the method for calculating a producer score performed by the producer evaluating unit 101 is described.

Here, the store evaluating unit 102 is capable of using, as the method for calculating a store score, an algorithm (PageRank) that calculates a level of importance using Markov decision process.

Where a group of stores for each of which a store score is calculated is denoted by W, and a store is denoted by u, a relation between W and u is expressed as u ∈ W. Here, a group of products sold by a store u is denoted by Fᵤ, and a group of producers who are suppliers of the store u is denoted by Bᵤ.

Moreover, the number of products is denoted by n, and the number of products at the store u is denoted by nᵤ (nᵤ=|Fᵤ|). A score (rank value) is denoted by r. The score takes a value from 0 to 1. A higher score means higher sensitivity to the sustainability of the society and a higher evaluation.

Here, a store score rᵤ is calculated by Equation (1) below.

$$\begin{matrix}[ Math . 1 ] & \\ {r}_{u} = c {\sum }_{v ∈ {B}_{u}} \frac{{r}_{v}}{{n}_{v}} ( {n}_{u} = \vert {F}_{u} \vert ) & Equation ( 1 )\end{matrix}$$

It is to be noted that in Equation (1), c is an attenuation coefficient and varies with a nature of a supply relationship between a producer and a store. For instance, if, instead of direct transactions, a delivery company and a distributor lie between the producer and the store, setting c appropriately makes it possible to consider the sensitivity of the delivery company and the distributor to the sustainability of the society.

It is to be noted that although the method for calculating a level of importance using Markov decision process is used as the method for calculating a store score in Embodiment 1, the present disclosure is not limited to this, and another publicly known algorithm may be used.

The following describes another exemplary method for calculating a store score.

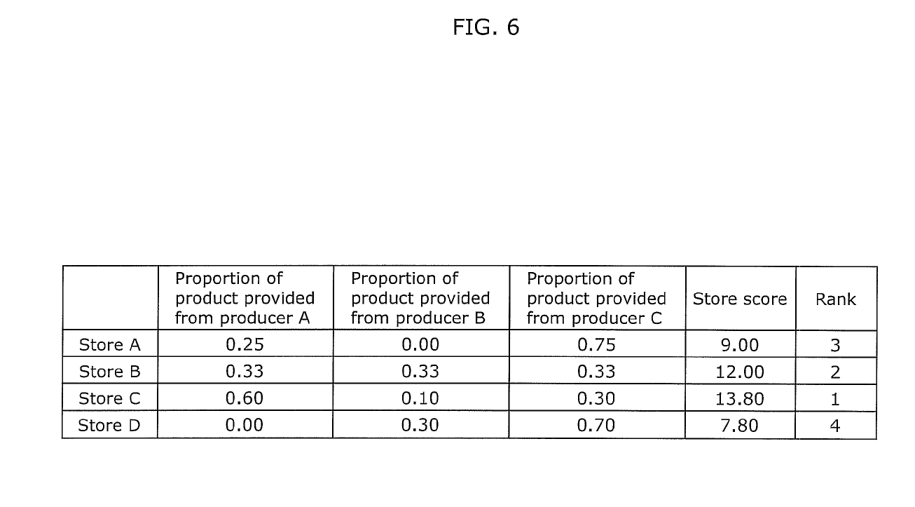

FIG. 6 is a diagram illustrating the other exemplary method for calculating a store score.

In an example shown in FIG. 6, producer scores are the values determined in FIG. 5. In other words, the producer scores of Producer A, Producer B, and Producer C are 18 points, 12 points, and 6 points, respectively.

In the example shown in FIG. 6, the store evaluating unit 102 multiplies together each of proportions of products provided to the stores by respective Producer A, Producer B, and Producer C and the producer score of each of Producer A, Producer B, and Producer C. A sum of the values resulting from the multiplication is a store score. If the proportion of the products is put into a weight, the store evaluating unit 102 calculates a sum of weighted producer scores as a store score.

It is to be noted that a proportion of the products provided by each producer means a proportion of the products provided by the producer to all products sold by each store. In addition, the proportions of the products are determined by purchase information.

In the example shown in FIG. 6, the store score of Store A is 0.25×18+0.75×6=9.00 points. Likewise, the store score of Store B is 0.33×18+0.33×12+0.33×6=12.00 points. Similarly, the store score of Store C is 13.80 points, and the store score of Store D is 7.80 points.

The store evaluating unit 102 ranks Stores A to D based on the store scores thus calculated. In the example shown in FIG. 6, Store C, Store B, Store A, and Store D are ranked in descending order of store score. To put it another way, the store evaluating unit 102 calculates a higher store score for a store having a higher proportion of products provided by a producer having a higher producer score, based on the purchase information, and ranks the store having the higher store score higher.

The output unit 105 transmits to the information communication device 200 ranking information about the stores determined by the ranking of the store evaluating unit 102, and the display unit 201 of the information communication device 200 displays the information about the ranked stores as shown in (b) of FIG. 1.

### (1-6. Summary)

As described above, the store ranking device 100 according to Embodiment 1 is capable of quantitatively evaluating whether or not the producers of the products and the services selected and concentrated by the stores/companies are sensitive to the sustainability of the society in the production processes. Then, the store ranking device 100 is capable of ranking the stores/companies using the producer scores that are the evaluation results of the producers, and preferentially presenting to the user the information about the highly evaluated stores/companies.

Thus, according to the store ranking system 10 (store ranking device 100), the user can obtain the information about the stores/companies ranked based on their sensitivity to the sustainability of the society.

### Other Embodiments

Embodiment 1 has been thus described as an exemplary implementation in the present disclosure. However, the present disclosure is not limited to Embodiment 1, but can be applied to an embodiment obtained by appropriately performing modification, replacement, addition, omission, and the like on each of the above-described embodiments. In addition, a new embodiment can be obtained by combining each of the structural elements described in Embodiment 1.

For instance, although the producer scores are calculated by the producer evaluating unit 101 in the above-described embodiments, producer scores may be previously stored in the second storage unit 104. In other words, the producer evaluating unit 101 is not an essential structural element.

Moreover, although in the above-described embodiments the example is described where the store scores are calculated based on the numbers of the products (agricultural products) included in the purchase information, store scores may be calculated based on quantities of products such as weights of products.

Each of the structural elements in each of the above-described embodiments may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk and a semiconductor memory. Here, the software program for realizing the store ranking device according to each of the above-described embodiments is a program described below.

The program causes a computer to execute a method for ranking a plurality of stores to support a consumption behavior of a user which is sensitive to sustainability of a society, the method including calculating, for each of the stores, a store score of the store based on purchase information and a producer score, the purchase information including (a) information indicating at least one producer who provides the store with a product and (b) information indicating a quantity of the product provided by the at least one producer, and the producer score being determined for each of the at least one producer and indicating sensitivity of the at least one producer to the sustainability of the society; ranking the stores based on the calculated store scores; and outputting ranking information indicating the ranks of the stores.

These general and specific aspects of the present disclosure may be implemented using a system, a method, an integrated circuit, a computer program, or a computer-readable recording medium such as a CD-ROM. In addition, the general and specific aspects of the present disclosure may be implemented using any combination of systems, methods, integrated circuits, computer programs, or recording media.

It is to be noted that the present disclosure may be realized as an organization ranking device. Here, the term “organization” refers to the above-described stores, manufacturing or service companies, and various organizations such as prefectural government offices.

The organization ranking device calculates organization scores of organizations based on supply information and a supplier score determined for each of at least one supplier and indicating an evaluation of the at least one supplier. Here, the supply information includes information indicating at least one supplier who supplies products to the organization, and information indicating quantities of the products supplied by the at least one supplier. The organization ranking device ranks the organizations based on the calculated organization scores.

Here, for example, if an organization is a manufacturing company, a supplier is a company that supplies components and materials to the manufacturing company.

According to such an organization ranking device, a user can obtain information about the organizations ranked based on the evaluations of the suppliers.

As stated above, the detailed description and the accompanying drawings have described Embodiment 1 and the other embodiments that the applicant considers as the best mode. These are provided for a person skilled in art so as to illustrate the subject matter recited in the CLAIMS by reference to a specific embodiment.

Thus, the structural elements described in the detailed description and the accompanying drawings may include not only structural elements essential to solve the problem but also other structural elements. For this reason, even if these inessential structural elements are described in the detailed description and the accompanying drawings, it should not be immediately recognized that the inessential structural elements are essential.

Moreover, it is possible to perform various types of modification, replacement, addition, omission, or the like on the above-described embodiments within the scope the CLAIMS or the equivalent thereof.

### INDUSTRIAL APPLICABILITY

The store ranking device according to the present disclosure makes it possible to preferentially provide a user aiming at establishing a sustainable society with information about stores/companies selling more products and services sensitive to the environment. Thus, the store ranking device according to the present disclosure is useful as a device capable of increasing the chance of finding products and services suitable for the user.

1. A store ranking device that ranks a plurality of stores to support a consumption behavior of a user which is sensitive to sustainability of a society, the store ranking device comprising
a processor that (i) calculates, for each of the stores, a store score of the store based on purchase information and a producer score, (ii) ranks the stores based on the calculated store scores, and (iii) outputs ranking information indicating the ranks of the stores, the purchase information including (a) information indicating at least one producer who provides the store with a product and (b) information indicating a quantity of the product provided by the at least one producer, and the producer score being determined for each of the at least one producer and indicating sensitivity of the at least one producer to the sustainability of the society.

2. The store ranking device according to claim 1,
wherein where a group of products sold by a store u included in the stores is denoted by Fᵤ, a group of the at least one producer who provides the store u with a product is denoted by Bᵤ, the number of the products sold by the store u is denoted by nᵤ, and an attenuation coefficient is denoted by c, a store score rᵤ of the store u is calculated by an equation below.
$${r}_{u} = c {\sum }_{v ∈ {B}_{u}} \frac{{r}_{v}}{{n}_{v}} ( {n}_{u} = \vert {F}_{u} \vert )$$

3. The store ranking device according to claim 1,
wherein the producer score is higher as the at least one producer is more sensitive to the sustainability of the society, and
the processor calculates, based on the purchase information, a higher store score for a store having a higher proportion of a product provided by a producer having a high producer score, and ranks higher the store having the higher store score.

4. The store ranking device according to claim 1,
wherein the processor further calculates, for each of the at least one producer, the producer score depending on the sensitivity of the at least one producer to the sustainability of the society.

5. The store ranking device according to claim 4, further comprising
a first storage unit configured to store an evaluation table in which an evaluation index for evaluating the sensitivity of the at least one producer to the sustainability of the society is defined,
wherein the processor reads the evaluation table from the first storage unit and calculates, for each of the at least one producer, the producer score by reference to the evaluation index included in the read evaluation table.

6. The store ranking device according to claim 5,
wherein a plurality of the evaluation indexes include (1) an index indicating sensitivity of the at least one producer to a production environment of a product, (2) an index indicating sensitivity of the at least one producer to a producing area of a product, (3) an index indicating particularity of the at least one producer about a production process of a product, and (4) an index indicating sensitivity of the at least one producer to a season of a product.

7. The store ranking device according to claim 6,
wherein in the evaluation table, a criterion for determining the sensitivity to the producing area of the product is at least one of a distance between a production place of a product and a sales place of the product, a store format of a store selling a product produced or processed by a producer, and a size of a branch store of the store.

8. The store ranking device according to claim 6,
wherein in the evaluation table, a criterion for determining the particularity about the production process of the product is at least one of a proportion of a product of species originated in a producing area and the number of welfare activities performed using a product.

9. The store ranking device according to claim 1, further comprising
a second storage unit configured to store the purchase information and the producer score,
wherein the processor reads, for each of the stores, the purchase information and the producer score from the second storage unit and calculates the store score of the store based on the purchase information and the producer score that are read.

10. An organization ranking device that ranks a plurality of organizations, the organization ranking device comprising
a processor that
(i) calculates, for each of the organizations, an organization score of the organization based on supply information and a supplier score, (ii) ranks the organizations based on the calculated organization scores, and (iii) outputs ranking information indicating the ranks of the organizations, the supply information including (a) information indicating at least one supplier who supplies the organization with a product and (b) information indicating a quantity of the product supplied by the at least one supplier, and the supplier score being determined for each of the at least one supplier and indicating an evaluation of the at least one supplier.

11. A method for ranking a plurality of stores to support a consumption behavior of a user which is sensitive to sustainability of a society, the method comprising:
calculating, for each of the stores, a store score of the store based on purchase information and a producer score, the purchase information including (a) information indicating at least one producer who provides the store with a product and (b) information indicating a quantity of the product provided by the at least one producer, and the producer score being determined for each of the at least one producer and indicating sensitivity of the at least one producer to the sustainability of the society;
ranking the stores based on the calculated store scores; and
outputting ranking information indicating the ranks of the stores.

12. A non-transitory computer-readable recording medium for use in a computer, the recording medium having a computer program recorded thereon for causing the computer to execute the method according to claim 11.
